(19) United States
(12) Patent Application Publication
(10) Pub. No.: US 2007/0291434 A1
(43) Pub. Date: Dec. 20, 2007

(54) Protection circuit

(75) Inventor: Takahiro Sato, Gunma (JP)

Correspondence Address: MORGAN LEWIS & BOCKIUS LLP, 1111 PENNSYLVANIA AVENUE NW, WASHINGTON, DC, 20004, US

(73) Assignee: Yokowo Co., Ltd.

(21) Appl. No.: 11/812,181

(22) Filed: Jun. 15, 2007

(30) Foreign Application Priority Data
Jun. 16, 2006 (JP) P.2006-167378

(51) Int. Cl. H02H 3/00

(52) U.S. Cl. 361/100

(57) ABSTRACT

A transistor is coupled to a load so that an input voltage is applied to the load therethrough. A comparator compares a load-side voltage of the transistor with a reference voltage. A control circuit is operable to deactivate the transistor when the comparator detects that the load-side voltage is lower than the reference voltage. The transistor is so configured as to operate in a non-saturated region when an overcurrent flows in the load, so that the load-side voltage thereof becomes lower than the reference voltage.

### BACKGROUND

This invention relates to a protection circuit for blocking an overcurrent from flowing through a load due to its abnormality, and a protection circuit for passing a current through the load when the load returns to a normal state.

Now referring to FIG. 5, an explanation will be given of an example of the protection circuit for blocking an overcurrent from flowing through a load due to load abnormality such as short-circuiting. In FIG. 5, an input voltage a is applied to a load 10 through the series of an emitter-collector of an NPN transistor Tr1, a current detecting resistor RY, and a switch SW on the load side. The input terminal of the input voltage a is connected to the emitter of a PNP transistor Tr2 through a base current control resistor RB and the collector of the PNP transistor Tr2 is connected to the base of the transistor Tr1. The base of the transistor Tr2 is grounded through the collector-emitter of an NPN transistor Tr3. Further, the voltage on the load side of the current detecting resistor RY is applied to the one input terminal of a comparator c. To the other input terminal of the comparator c, a reference voltage b is applied. The output terminal of the comparator c is connected to the base of the transistor Tr3. Further, a bias voltage appropriately set by dividing the input voltage a by a pull-up resistor R1 and a base bleeder resistor R2, is applied to this output terminal.

In such a configuration, when the switch SW on the load side is closed, the input voltage a is applied to a load 10. Now, if an overcurrent flows due to abnormality such as short-circuiting in the load 10, a large voltage drop occurs at the current detecting resistor RY. The voltage applied to the one input terminal of the comparator c thereby becomes smaller than the reference voltage b. The comparator c detects such decrease of the input voltage so that it generates “L” level signal at its output terminal, thereby turning the transistor Tr1 off. As a result, the overcurrent flowing through the load 10 is blocked. Now, the base current control resistor RB is set for e.g. 150Ω so that the transistor Tr1 operates in a saturated range. So, even when the overcurrent flows, the emitter-collector voltage does not become so large.

Japanese Patent Publication No. 63-59718A discloses a technique for continuously passing an overcurrent for a prescribed time period even when the overcurrent flowing through the load is detected and thereafter repeating the ON/OFF switching of the overcurrent. In the technique disclosed in this publication, even when it is detected that the voltage applied to the load has lowered due to the overcurrent flowing through the load, the overcurrent is not immediately blocked, but blocked after a prescribed time period elapses. In this manner, the current will not be blocked due to an inrush current flowing into a capacitor of a voltage ripple filter and other circuit components.

In the protection circuit shown in FIG. 5, the current detecting resistor RY for detecting the overcurrent is necessary. Since this current detecting resistor RY is a relatively high power rating resistor, and has a large outside size that requires a wide installing space, and further is expensive. Further, even when the load is in an abnormal state such as short-circuiting, the overcurrent intermittently flows through the load. Thus, if the power source is a battery for example, there is a drawback that the battery is severely consumed.

### SUMMARY

It is therefore one advantageous aspect of the invention to provide a protection circuit which does not require a current detecting resistor and blocks a current if a load is in an abnormal state such as a short-circuiting but passes the current again if the load returns to a normal state.

According to one aspect of the invention, there is provided a protection circuit, comprising:

a load;

a transistor, coupled to the load so that an input voltage is applied to the load therethrough;

a comparator, comparing a load-side voltage of the transistor with a reference voltage; and

a control circuit, operable to deactivate the transistor when the comparator detects that the load-side voltage is lower than the reference voltage, wherein:

the transistor is so configured as to operate in a non-saturated region when an overcurrent flows in the load, so that the load-side voltage thereof becomes lower than the reference voltage.

With this configuration, when an overcurrent flows due to abnormality of a load such as short-circuiting, the emitter-collector voltage of the transistor increases so that the voltage on the load side of the transistor becomes lower than the reference voltage. This fact is detected by the comparator. Thus, the transistor is turned off and the overcurrent is immediately blocked. Since the overcurrent is detected by changes in the emitter-collector voltage of the transistor, unlike the related-art, the current detecting resistor is not required. For this reason, the number of components is reduced and in addition, an expensive component can be omitted.

The protection circuit may further comprise a restoring resistor, connected to the transistor in a parallel manner, so that a minute current flows in the load even when the transistor is deactivated by the control circuit.

In this case, a restoring resistor is connected in parallel to the transistor. So, if the load returns to a normal state, due to the current flowing through the restoring resistor, the voltage on the load side of the transistor returns to a normal value thereby to become higher than the reference voltage. Thus, the transistor is turned on again.

### BRIEF DESCRIPTION OF THE DRAWINGS

FIG. 1 is a circuit diagram showing a protection circuit according to a first embodiment of the invention.

FIG. 2 is a graph showing a characteristics of the protection circuit of FIG. 1.

FIG. 3 is a circuit diagram showing a protection circuit according to a second embodiment of the invention.

FIG. 4 is a circuit diagram showing a protection circuit according to a third embodiment of the invention.

FIG. 5 is a circuit diagram showing a related-art protection circuit.

### DETAILED DESCRIPTION OF THE EXEMPLIFIED EMBODIMENTS

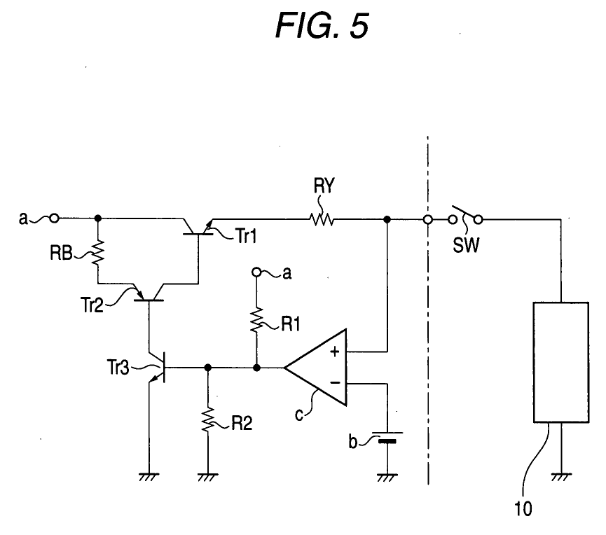

Exemplified embodiments of the invention will be described below in detail with reference to the accompanying drawings. Components similar to those in the related-art shown in FIG. 5 will be designated by the same reference numerals and repetitive explanations for those will be omitted.

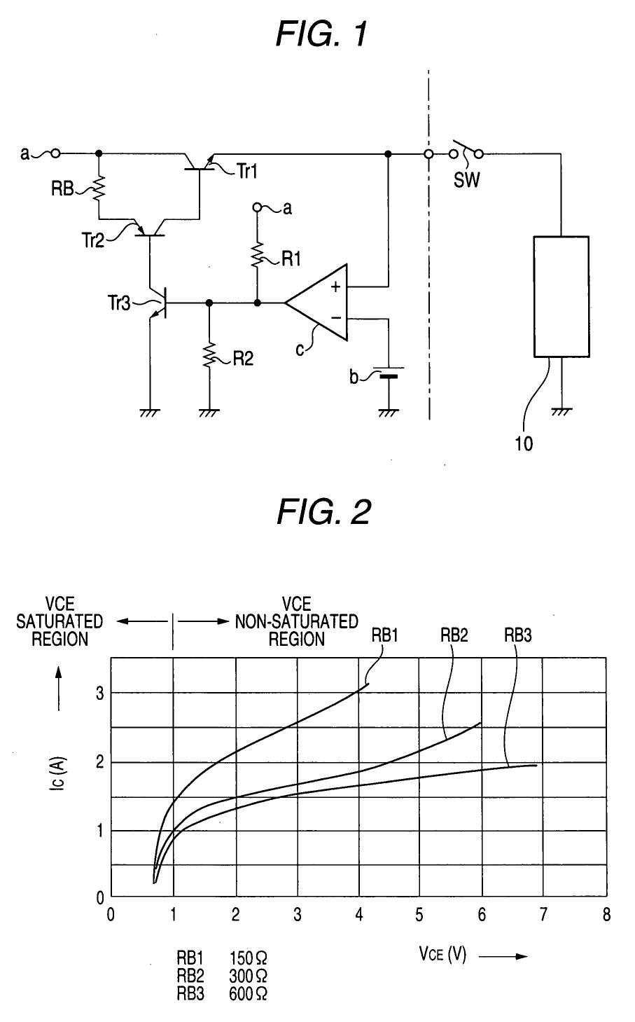

A protection circuit according to a first embodiment of the invention shown in FIG. 1 is different from the related-art shown in FIG. 5 in that the current detecting resistor RY is omitted and the collector of the transistor Tr1 is directly connected to the load side. The transistor Tr1 operates in an non-saturated region when the overcurrent flows due to the abnormal state of the load such as short-circuiting so that the voltage drop between the emitter and collector thereof abruptly increases. Thus, the voltage on the load side becomes lower than the reference voltage b. In order to implement this process, the base current of the transistor Tr1 is set by the base current control resistor RB. For example, in the characteristic graph of FIG. 2, the base current control resistor RB is set for e.g. 300Ω or 600Ω.

In such a configuration, in a state where the load 10 is normal and as the collector current of the transistor Tr1, the current of 200 to 400 mA flows, the emitter-collector voltage is about 0.7 V. However, in a state where the load 10 is abnormal like short-circuiting and as the overcurrent not smaller than a prescribed current value of e.g. 1.2 A, the current 1.5 to 2 A flows, the emitter-collector voltage of the transistor Tr1 abruptly greatly changes by 3 to 4 V or larger which is not lower than a prescribed voltage value. So, a large voltage drop of the emitter-collector voltage of the transistor Tr1 can be surely detected by the comparator c, thereby switching the transistor Tr1 off. Thus, the normality or abnormality of the load 10 can be surely detected.

Namely, in this embodiment, the operation of the current detecting resistor RY in the related-art shown in FIG. 5 is executed by the transistor Tr1. Thus, the installing space for the circuit may be small by the degree of omitting the current detecting resistor RY in the related-art shown in FIG. 5. In addition, the expensive component is omitted and so economical. Further, since there are a small number of components, the manufacturing process can be simplified.

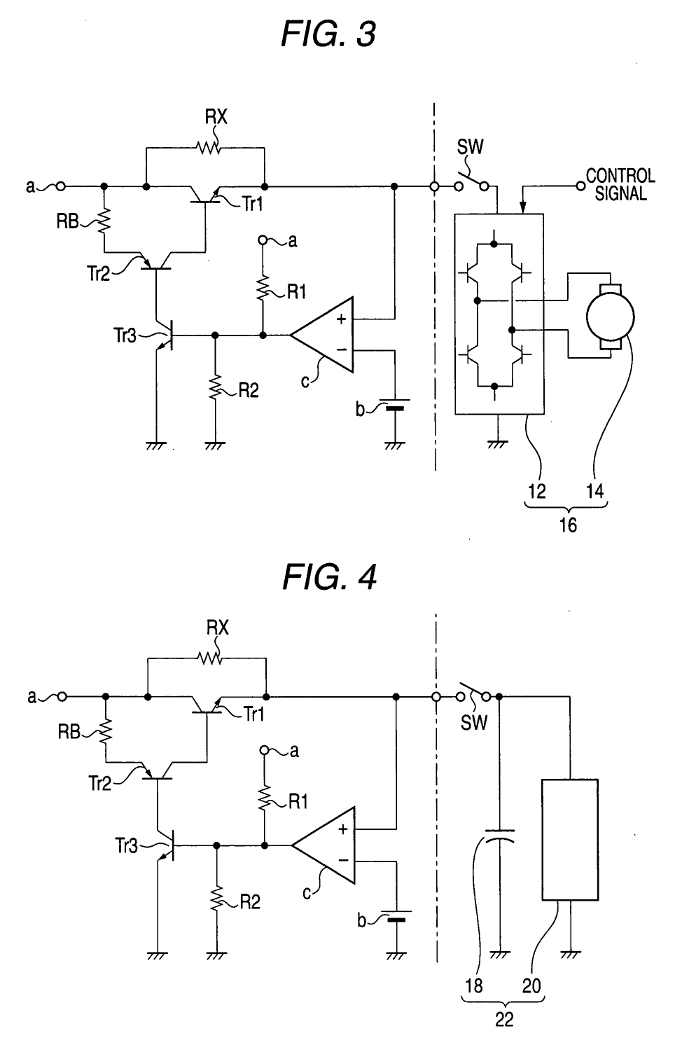

Next, a second embodiment of the invention will be described with reference to FIG. 3. Components similar to those in the first embodiment will be designated by the same reference numerals and repetitive explanations for those will be omitted.

The second embodiment is different from the first embodiment in that a restoring resistor RX is connected in parallel between the emitter and collector of the transistor Tr1. The restoring resistor RX is set for e.g. 100Ω. Further, to the load side, a motor control circuit 16 serving as the load is connected through the switch SW. This motor control circuit 16 is designed so that a driving circuit 12 composed of electronic components such as transistors appropriately makes the forward rotation or reverse rotation of a motor 14 according to a control signal.

In such a configuration, when the switch SW on the load side is closed, if the motor control circuit 16 serving as the load is normal, the voltage on the load side of the transistor Tr1 is higher than the reference voltage b so that the On-state of the transistor Tr1 is maintained. However, if the driving circuit 12 malfunctions due to superposition of external noise on the control signal to give rise to the short-circuited state, the overcurrent not smaller than a prescribed current value flows through the driving circuit 12. Thus, the emitter-collector voltage of the transistor Tr1 becomes greater than the prescribed voltage, which makes the load-side voltage of the transistor Tr1 lower than the reference voltage b. This is detected by the comparator c and the transistor Tr1 is immediately switched off, thereby blocking the overcurrent.

While the transistor Tr1 is switched off, a minute current of e.g. about 1 μA flows toward the load side through the restoring resistor RX. Now, when the external noise disappears and the driving circuit 12 returns to the normal state, due to the current flowing via the restoring resistor RX, the voltage on the load side of the transistor Tr1 becomes high to exceed the reference voltage b. Thus, the signal at the output terminal of the comparator c is inverted into “H”, and the transistor Tr1 is turned on again by this “H” signal. In this way, when the load is in the abnormal state, the transistor Tr1 is turned off whereas when the load returns to the normal state, the transistor Tr1 is turned on. Additionally, the off-state of the transistor Tr1 is not limited to the case where the load is abnormal, but also occurs in the case where the voltage value of the input voltage a instantaneously lowers due to e.g. external noise so that the voltage on the load side of the transistor Tr1 instantaneously becomes lower than the reference voltage b. Also in such a case, when the input voltage a returns to the normal state, the transistor Tr1 is turned on again.

Next, a third embodiment of the invention will be described with reference to FIG. 4. Components similar to those in the first embodiment will be designated by the same reference numerals and repetitive explanations for those will be omitted.

The third embodiment is different from the second embodiment in its circuit configuration on the load side. Specifically, to the load side of the transistor Tr1, an electronic circuit 22 composed of a capacitor 18 serving as a voltage ripple filter capacitor and an amplifying circuit 20 which are connected in parallel, is connected as a load through the switch SW. The voltage ripple filter capacitor 18 is relatively large in capacitance so that when the switch SW is closed, a large inrush current flows into the capacitor 18. Then, the voltage drop between the emitter and collector of the transistor Tr1 becomes large. This is detected by the comparator c so that the transistor TR1 is immediately turned off. However, a minute current flows toward the load side through the restoring resistor RX so that the voltage ripple filter capacitor 18 is gradually charged. The voltage on the load side of the transistor Tr1 is also gradually increased. When this voltage exceeds the reference voltage b, such excess is detected by the comparator c, and the transistor Tr1 is turned on again. In this way, even if the voltage ripple filter capacitor 18 having a large capacitance is provided on the load side, the circuit according to the invention avoids the inconvenience that the transistor Tr1 remains the off state undesirably. Incidentally, it will be easily understood that the circuit connected in parallel to the voltage ripple filter capacitor 18 should not be limited to the amplifying circuit 20, but may be any circuit such as an oscillating circuit which requires a filtered input voltage.

In the embodiments described above, the transistors Tr1 and Tr2 are connected in a Darlington connection, but without being limited to such a connection, the collector of the transistor Tr3 may be directly connected to the base of the transistor Tr1. Further, the transistor Tr1 should not be limited to an NPN type but may be a PNP type. It is needless to say that the connecting position of the base current control resistor RB and others may be appropriately changed according to such a circuit configuration.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

The disclosure of Japanese Patent Application No. 2006-167378 filed Jun. 16, 2006 including specification, drawings and claims is incorporated herein by reference in its entirety.

What is claimed is:

1. A protection circuit, comprising:
a load;
a transistor, coupled to the load so that an input voltage is applied to the load therethrough;
a comparator, comparing a load-side voltage of the transistor with a reference voltage; and
a control circuit, operable to deactivate the transistor when the comparator detects that the load-side voltage is lower than the reference voltage, wherein:
the transistor is so configured as to operate in a non-saturated region when an overcurrent flows in the load, so that the load-side voltage thereof becomes lower than the reference voltage.

2. The protection circuit as set forth in claim 1, further comprising:
a restoring resistor, connected to the transistor in a parallel manner, so that a minute current flows in the load even when the transistor is deactivated by the control circuit.

3. The protection circuit as set forth in claim 2, wherein:
the load is a circuit operable to drive a motor.

4. The protection circuit as set forth in claim 2, wherein:
the load is a circuit including a voltage ripple filter capacitor.
